(19) United States
(12) Patent Application Publication
(10) Pub. No.: US 2026/0024767 A1
(43) Pub. Date: Jan. 22, 2026

(54) Alkali-Metal Electrochemical Cells That Include Anodes Containing Salts and/or Additives, and Related Methods

(71) Applicant: SES Holdings Pte. Ltd., Singapore (SG)

(72) Inventors: Arunkumar Tiruvannamalai, Andover, MA (US); Hong Gan, Woburn, MA (US); Venkata Adiraju, North Andover, MA (US)

(21) Appl. No.: 19/273,629

(22) Filed: Jul. 18, 2025

Related U.S. Application Data
(60) Provisional application No. 63/673,986, filed on Jul. 22, 2024.

(51) Int. Cl. H01M 4/62; H01M 4/04; H01M 4/134; H01M 10/42

(52) U.S. Cl. CPC H01M 4/62; H01M 4/0404; H01M 4/0435; H01M 4/134; H01M 10/4235

(57) ABSTRACT

Composite anodes for electrochemical energy-storage cells in which each composite anode includes an anode-active layer that provides a reservoir for one or more types of material. In some embodiments, the electrochemical cell at issue uses an electrolyte salt, and at least one of the reservoir materials is an additional amount of the salt. In some embodiments, at least one of the reservoir materials is an additive that enhances the performance of the electrochemical cell. Methods of forming composite anodes are also disclosed, including: a process of forming a mixture of particles of anode-active material and particles for the reservoir and then calendering the mixture to form a monolithic layer; a process of providing an anode-active layer and pressing reservoir particles into a surface of the anode-active layer; and encapsulating reservoir particles between anode-active layers. Electrochemical cells using the composite anodes are also disclosed.

### RELATED APPLICATION DATA

This application claims the benefit of priority of U.S. Provisional Patent Application Ser. No. 63/673,986, filed on Jul. 22, 2024, and titled “ALKALI-METAL ELECTROCHEMICAL CELLS THAT INCLUDE ANODES CONTAINING SALTS AND/OR ADDITIVES, AND RELATED METHODS”, which is incorporated herein in its entirety.

### FIELD

The present disclosure generally relates to the field of alkali-metal batteries. In particular, the present disclosure is directed to electrochemical energy-storage cells that include anodes containing salts and/or additives, and related methods.

### BACKGROUND

Electrolyte used in a lithium battery is typically a mixture of salt and solvent. The salt dissolves in the solvent and provides the ions necessary for ionic conductivity of the electrolyte. In this regard, it is essential to maintain the concentration of salt in the electrolyte for continuous operation and optimal performance of the battery. In a rechargeable lithium-metal battery, an electrolyte having a lithium salt dissolved in an organic solvent is typically employed. During charge-discharge cycling of the battery, lithium metal is, respectively, plated and stripped at the anode. As the lithium is highly reactive, the electrolyte contributes to forming a solid-electrolyte-interphase (SEI) layer that passivates its surface and prevents continuous reaction of lithium with electrolyte.

### SUMMARY

In one implementation, the present disclosure is directed to an electrochemical energy-storage cell, which includes a container; a core contained within the container, wherein the core comprises an anode, a cathode, and a separator electrically separating the anode and the cathode; and an electrolyte contained within the container and in functional contact with the core so as to conduct, during operation of the electrochemical energy-storage cell, ions between the anode and the cathode, the electrolyte comprising a first salt and solvent and having a salt concentration; wherein the anode includes: an alkali metal as an anode-active material; and a second salt incorporated into the alkali metal, the second salt provided in an amount determined as a function of the salt concentration of the electrolyte.

In another implementation, the present disclosure is directed to an electrochemical energy-storage cell, which includes a container; a core contained within the container, wherein the core comprises an anode, a cathode, and a separator electrically separating the anode and the cathode; and an electrolyte contained within the container and in functional contact with the core so as to conduct, during operation of the electrochemical energy-storage cell, ions between the anode and the cathode, the electrolyte comprising an alkali-metal salt and solvent and having a salt concentration; wherein the anode includes: an alkali metal as an anode-active material; and a functional additive incorporated into the alkali metal as particulates, wherein the functional additive is selected and provided in an amount to, at least one of: contribute to formation of a solid-electrolyte interphase layer on the anode during charge-discharge cycling of the electrochemical energy-storage cell; contribute to formation of a cathode-electrolyte interphase layer on the cathode during charge-discharge cycling of the electrochemical energy-storage cell; and participate in chemical reduction on the anode so as to free ions of the alkali metal of the anode-active material during charge-discharge cycling of the electrochemical energy-storage cell.

In yet another implementation, the present disclosure is directed to a method of forming an anode for an electrochemical energy-storage cell based on an electrolyte having a primary salt, wherein the electrochemical energy-storage cell includes a cathode. The method includes providing a current collector; coating a first precursor slurry onto the current collector so as to provide a first composite anode coating, wherein the first precursor slurry comprises: an alkali metal, in particulate form, as an anode-active material; a coating solvent for enabling the coating; and at least one of, in particulate form: a replenishment salt selected and provided in an amount to replenish the primary salt as the primary salt is depleted during charge-discharge cycling of the electrochemical energy-storage cell; and a functional additive selected and provided in an amount to, at least one of: contribute to formation of a solid-electrolyte interphase layer on the anode during charge-discharge cycling of the electrochemical energy-storage cell; contribute to formation of a cathode-electrolyte interphase layer on the cathode during charge-discharge cycling of the electrochemical energy-storage cell; and participate in chemical reduction on the anode so as to free ions of the alkali metal of the anode-active material during charge-discharge cycling of the electrochemical energy-storage cell; causing the first composite anode coating to cure so as to form a first composite anode layer; and calendering the first composite anode layer and the current collector so as to compact the first composite anode layer.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1A is a pair of optical microscopy images of an example composite anode coating made in accordance with aspects of the present disclosure, with the lefthand image showing the composite anode coating prior to calendering and the righthand image showing the composite anode coating after calendering;

FIG. 1B is a composite of schematic cross-sectional views illustrating an example process of the present disclosure for applying a composite anode coating to a current collector, with the lefthand and righthand views illustrating the composite anode coating, respectively, before and after calendering, and the middle reduced-size view illustrating the calendering;

FIG. 2A is a graph of C3-C3 cycle life versus cycle number for baseline cells and cells built with composite anode of the present disclosure containing various amounts of LiFSI salt;

FIG. 2B is a graph of normalized Direct Current Internal Resistance (nDCIR) measured at 50% State of Charge (SOC) versus cycle number for the cells of FIG. 2A;

FIG. 3A is a graph of fast-charge cycle life versus cycle number for baseline cells and cells built with composite anodes of the present disclosure containing a lower amount of LiFSI salt than present in the composite-anode cells of FIG. 2A;

FIG. 3B is a graph of nDCIR measured at 50% SOC versus cycle number for the cells of FIG. 3A;

FIG. 4A is a graph of C3-C3 cycle life versus cycle number for baseline cells and cells built with composite anodes of the present disclosure containing various amounts of LiFSI salt, including amounts that are larger than the amounts in the composite anodes of the cells of FIG. 2A;

FIG. 4B is a graph of nDCIR measured at 50% SOC versus cycle number for the cells of FIG. 4A;

FIG. 5A is a graph of C3-C3 cycle life versus cycle number for cells built with composite anodes of the present disclosure containing no additive and cells built with composite anodes of the present disclosure containing a magnesium salt additive (Mg(FSI)₂);

FIG. 5B is a graph of nDCIR measured at 50% SOC versus cycle number for the cells of FIG. 5A;

FIG. 6A is a graph of fast-charge cycle life versus cycle number for baseline cells, cells built with composite anodes of the present disclosure containing no additive, and cells built with composite anodes of the present disclosure containing an LiDFP additive;

FIG. 6B is a graph of C/3-C/3 cycle life versus cycle number for baseline cells, cells built with composite anodes of the present disclosure containing no additive, and cells built with composite anodes of the present disclosure containing an LiDFP additive;

FIG. 7 is a graph of fast-charge cycle life versus cycle number for cells built with composite anodes of the present disclosure containing LiFSI salt and cells built with composite anodes of the present disclosure containing LiFSI salt and an LiDFP additive;

FIG. 8 is a composite of schematic cross-sectional views illustrating an example surface-embedding process (upper view pair) and an example multilayer encapsulating process (lower view pair) for applying a composite anode coating to a current collector that are alternatives to the process of FIG. 1B, with the lefthand and righthand views of each of the upper and lower view pairs illustrating the composite anode coating, respectively, before and after calendering, and the central reduced-size view illustrating the calendering;

FIG. 9A is a graph of fast-charge cycle life versus cycle number for cells built with composite anodes of the present disclosure containing LiFSI salt and cells built with composite anodes containing LiFSI salt using the surface-embedding process of FIG. 8;

FIG. 9B is a graph of nDCIR measured at 50% SOC versus cycle number for the cells of FIG. 9A;

FIG. 9C is a graph of Reverse Coulombic Efficiency (RCE) versus cycle number for the cells of FIG. 9A; and

FIG. 10 is a simplified schematic diagram of an example electrochemical energy-storage cell made using one or more composite anodes of the present disclosure.

### DETAILED DESCRIPTION

The entire contents of the appended claims are incorporated into this Detailed Description section as if originally presented herein.

Unless otherwise indicated, the use of any of the singular elements “salt”, “additive”, “anode”, “cathode”, “separator”, and “solvent” in the example claims and below can connote a single type of each such element and a plurality of differing types of each such element. For example, “solvent” can indicate a single solvent or a mixture of differing solvents.

While examples below are directed to electrochemical energy-storage cells, aspects and features described herein are not necessarily limited to such lithium-metal cells. For example, another alkali metal, such as sodium or potassium, can be substituted for the working ions that flow between the anode(s) and cathode(s) of the cell at issue.

Throughout the present disclosure and in the appended claims, the term “about” when used with a corresponding numeric value refers to ±20% of the numeric value, typically ±10% of the numeric value, often ±5% of the numeric value, and most often ±2% of the numeric value. In some embodiments, the term “about” can mean the numeric value itself.

In conventional electrolytes having ˜1M lithium salt concentration, the solvent molecules that are present in abundance typically undergo reduction at the surface of the lithium-metal anode to form a solid-electrolyte-interphase (SEI) or passivation layer. Conversely, in a high-salt-concentration electrolyte, most of the solvent molecules will remain associated with the solvated Li⁺ ions from the salt and are not available to form the SEI layer. In the absence of free solvent molecules, a more compact and stable SEI layer is formed on the lithium-metal anode's surface by the anion of the lithium salt, which leads to higher lithium plating/stripping coulombic efficiency and better cycle life performance of the battery.

However, prolonged charge-discharge cycling leads to continuous depletion of salt and lowering of salt concentration in the electrolyte, and that eventually is detrimental to the cell performance. Even in a high-salt-concentration electrolyte, the solubility limit of salt in the solvent determines the maximum initial concentration that cannot be exceeded to compensate for the salt depletion during cycling. In this regard, it is advantageous to maintain a lithium salt reservoir inside the cell that could replenish the depleting salt concentration in the electrolyte and extend the cycle life of the battery.

In some aspects, the present disclosure pertains to using one or more lithium-metal anodes of a lithium-metal electrochemical energy-storage cell as a reservoir of salt and/or functional additive for the electrolyte employed in cell. In some embodiments, a composite anode of this disclosure, i.e., an anode containing a lithium-metal matrix as an anode-active material and the aforementioned reservoir, may be fabricated by incorporating particulate materials such as lithium salt and/or functional additive in the bulk of the lithium anode matrix. As cell cycling proceeds, the composite anode is gradually consumed and becomes more porous due to repeated plating and stripping of lithium on the surface of the composite anode. This gradually exposes the incorporated salt and/or functional additive to the electrolyte mixture and promotes local dissolution at the anode/electrolyte interface, which would in turn help to enhance and sustain electrolyte properties that are favorable for extended cycle life performance.

Conventional lithium-metal anodes are made by extrusion, roll-milling, and lamination of lithium metal foil on a copper current-collector substrate. This production process is not conducive for the uniform incorporation of particulate salt and/or functional additives in the bulk of the anode matrix. In an example embodiment of the present disclosure, the precursor used in the fabrication of the composite anode is a precursor slurry that contains lithium-metal particles, conductive diluents, and rheology modifiers dispersed in a hydrocarbon solvent and that can be cast, dried, and calendered, similar to the roll-to-roll processes widely used in the production of electrodes for lithium-ion batteries. In this precursor slurry, finely ground particulate materials of interest, such as lithium salts and/or functional additives, are first admixed before coating on the copper foil substrate. The coating is then dried to remove solvent and calendered to the desired thickness.

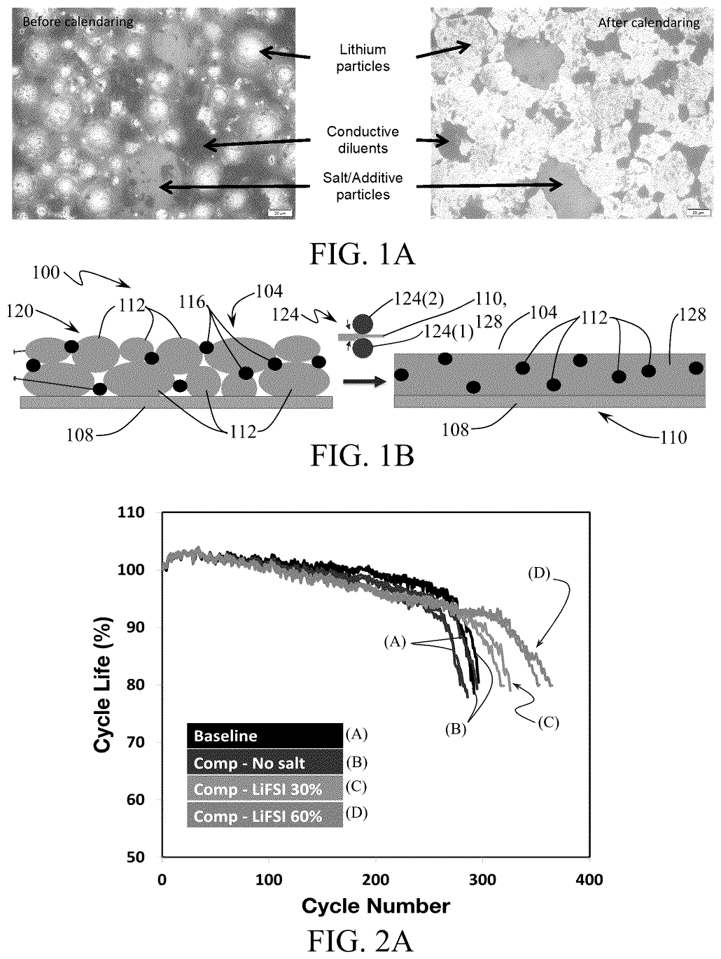

Due to the soft nature of lithium metal, the lithium-metal particles in the coating easily deform and entrap the other particulate material(s), such as, for example, salt particles and/or additive(s) (e.g., conductive diluent(s)), in the anode matrix during calendering, as shown physically in FIG. 1A and schematically in FIG. 1B. The porosity of the composite anode after calendering would be very low. This process allows for the uniform incorporation of particulate salt and/or additive in the bulk of the lithium-metal matrix and its gradual exposure to electrolyte upon cycling.

Referring particularly to FIG. 1B, this figure illustrates an example process 100 of applying a composite anode coating 104 to a substrate 108, such as a current collector (e.g., a copper current collector), to form a composite anode 110. In this example, the composite anode coating 104 is a lithium-metal based coating that comprises lithium-metal particles 112 (only some labeled to avoid clutter) and reservoir particles 116, some or all of which may be, for example, particles of one or more salts, such as any one or more of the salts mentioned below, or some or all of which may be particles of one or more additives, such as any one or more of the additives mentioned below. As seen on the lefthand side of FIG. 1B, the lithium-metal particles 112 and the reservoir particles 116 are initially applied to the substrate 108 relatively loosely, for example, as a mixture 120 of the multiple types of particles. Then, as illustrated at the calendering operation 124 in which the composite anode 110 is passed through a pair of calendering rollers 124(1) and 124(2), the mixture 120 is compressed so as to effectively form it into a unitary heterogeneous layer 128 and make the composite anode be a monolithic unitary structure. As seen on the righthand side of FIG. 1B, the result of the calendering operation 124 is that the reservoir particles 116 are dispersed within the lithium metal formed from the compressed lithium-metal particles 112.

Performance of composite anodes of this disclosure were tested in identical pouch-type secondary cells built with nickel-manganese-cobalt oxide (NMC) cathodes, microporous polyolefin-based separators, and a high-salt-concentration electrolyte containing LiFSI salt. The cells built with composite anodes were cycled between 3V and 4.3V, at either C/3-C/3 charge-discharge rate or at a “fast-charge” rate with average 1C charge and C/2 discharge rate. The cells were typically cycled until the capacity decreased to below 80% of the initial capacity (end of life). Salt and additive amounts in the composite anode are reported as a percentage of the metallic lithium mass in the anode, generally referred to herein as “weight-percent”, or “wt %”. Cell resistance growth reported are Direct Current Internal Resistance (DCIR) or normalized Direct Current Internal Resistance (nDCIR) values measured at 50% state-of-charge (SOC) every 25 or 50 cycles. Cell-overcharge values reported are reverse coulombic efficiency (RCE) ratios of charge capacity over previous discharge capacity during cycling.

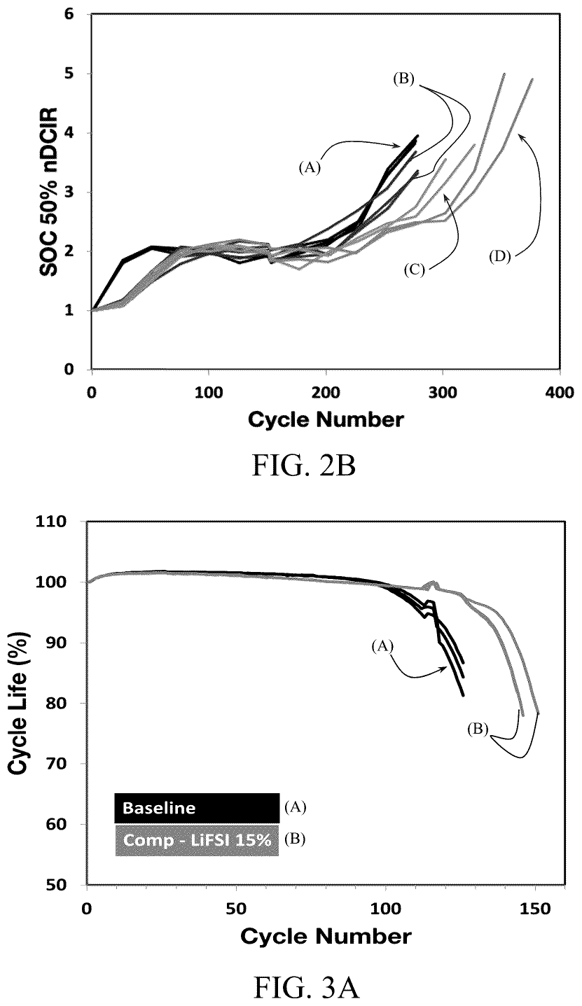

FIGS. 2A and 2B show, respectively, the C/3-C/3 cycling performance and DCIR resistance growth of cells built with composite anodes having various amounts of the LiFSI salt. In comparison to the baseline anode (made using laminated lithium foil) and composite anode with no salt addition, composite anodes having LiFSI salt were found to show higher cycle life performance and lower DCIR growth. Additionally, FIGS. 2A and 2B also shows the correlation between the salt content in composite anode and the cell performance, with the 60 wt % LiFSI anode showing relatively higher cycle life and lower DCIR growth than the 30 wt % LiFSI anode. A composite anode with 60 wt % LiFSI could potentially increase the salt concentration of the electrolyte by about 0.5M to about 1M, depending on the volume of electrolyte used in the cell, and that consequentially would lead to extension of the cycle life performance. A ˜15% improvement in the cell cycling performance was achieved using composite anode having 60 wt % LiFSI salt.

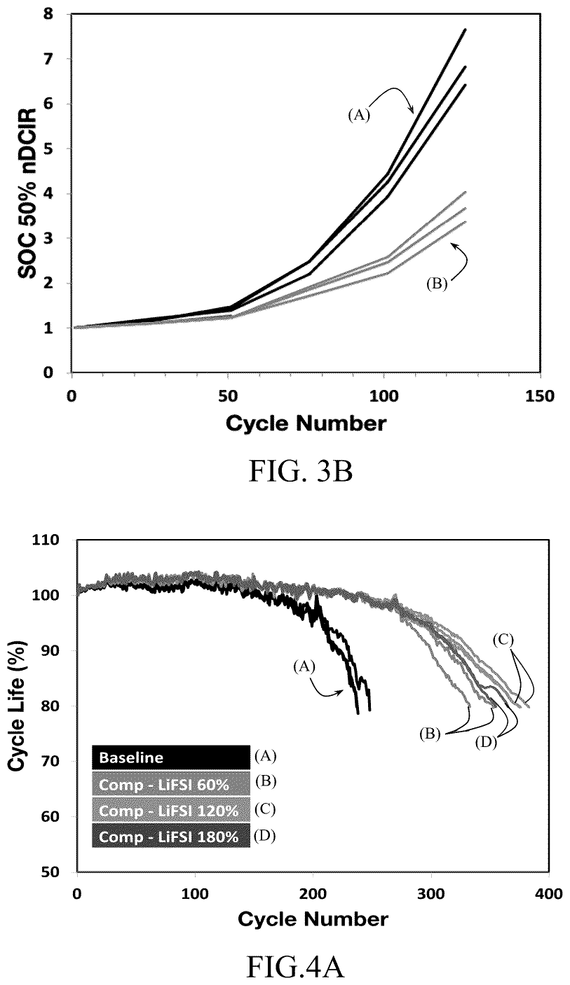

FIG. 3A shows the fast-charge cycling performance of cells built with composite anode having LiFSI salt. In comparison to the baseline anode, composite anode with 15 wt % LiFSI salt was found to show ˜25% improvement in the cell cycling performance. In addition, FIG. 3B also shows ˜50% lower DCIR resistance growth for composite anode with LiFSI salt, relative to the baseline at the end of life.

In essence, composite anodes containing lithium salt help replenish electrolyte salt concentration, which consequently extends cycle life and diminish resistance growth of the cell. Prolonged charge-discharge cycling of lithium metal cells will gradually deplete the salt concentration of the electrolyte, and having a lithium salt reservoir inside the cell would therefore help replenish the salt concentration and enhance the anode/electrolyte interface properties that are favorable for fast-charge durability and cycle life performance.

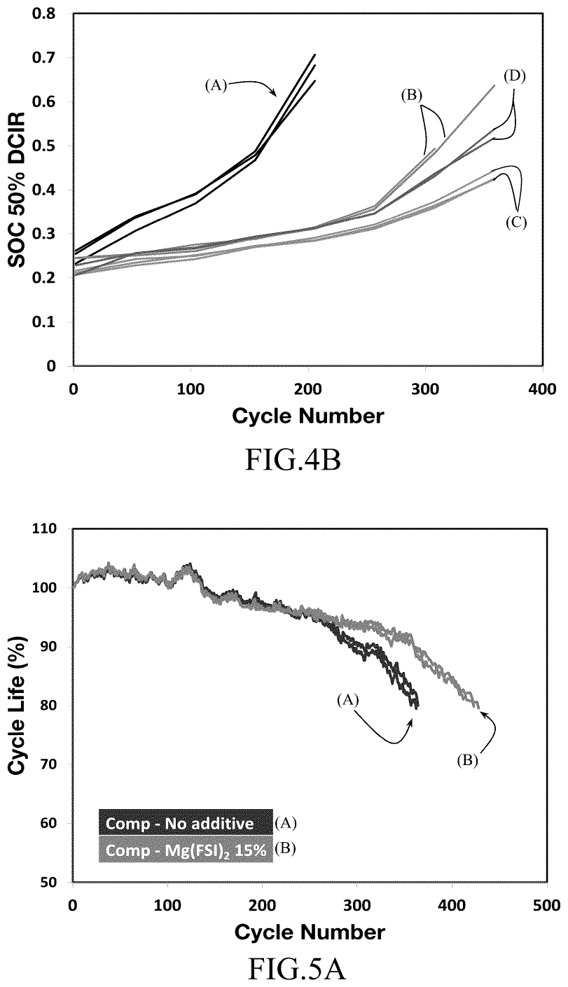

As the salt content in the composite anode increases, the relative amount of lithium-metal anode-active material decreases. Beyond a certain salt amount, the decreasing the amount of the lithium-metal anode-active material in the composite anode would have an adverse effect on the cycle performance of the cell. FIGS. 4A and 4B show, respectively, the C/3-C/3 cycling performance and DCIR resistance growth of cells built with composite anodes having various larger amounts of the LiFSI salt. In comparison to a composite anode containing 120 wt % LiFSI, a composite anode containing 180 wt % LiFSI salt was found to show relatively lower cycle life performance and higher DCIR growth. This indicates the range at which the adverse effect of decreasing lithium-metal anode-active content begins overshadowing the benefits of adding salt in the composite anode for performance enhancement. Moreover, incorporation of salt increases the thickness and mass of the composite anode, which consequently can have a negative impact on the volumetric and gravimetric energy densities of the cell. In essence, although incorporating up to about 180 wt % of LiFSI salt in composite anode was found to enhance cell performance, a presently preferred range is from about 5 wt % to about 120 wt % and a presently most preferred range is from about 30 wt % to about 60 wt %. Other ranges and values are possible, such as about 20 wt % to about 80 wt % and about 30 wt % to about 70 wt %, among others.

Furthermore, functional additives that show low solubility in high-salt-concentration liquid electrolytes could alternatively or additionally be embedded in the composite anode to promote gradual dissolution in the electrolyte. Sustained local dissolution of some functional additives at the anode/electrolyte interface would help enhance SEI layer properties and lithium plating/stripping efficiency favorable for fast-charge durability and cycle life performance. Gradual dissolution of some functional additives in the electrolyte would also help to enhance cathode-electrolyte-interface (CEI) properties and electrochemical performance of the cathode in the cell.

FIGS. 5A and 5B shows the C/3-C/3 cycling performance and DCIR resistance growth of cells built with composite anodes containing a magnesium salt additive. In comparison to the composite anode with no additive, a composite anode with 15 wt % Mg(FSI)₂ (FSI=bis(fluorosulfonyl)imide) was found to show higher cycle life and lower DCIR growth. The gradual dissolution of Mg(FSI)₂ in the electrolyte generated Mg²⁺ ions, which are known to improve the interfacial properties by forming an Li—Mg alloy at the anode surface. Furthermore, the reduction of Mg²⁺ ions at the anode surface led to the formation of Lit ions and a consequent increase in the lithium-salt concentration of the electrolyte. These improvements in the interfacial and electrolyte properties led to an enhancement in the cycle life performance and resistance growth of the cell. A composite anode with 15 wt % Mg(FSI)₂ additive exhibited an about 20% increase in the cell cycling performance at C/3-C/3 cycling rate. A currently preferred range of Mg(FSI)₂ additive in composite anode is from about 5 wt % to about 30 wt %, though other ranges and values are possible. Although Mg(FSI)₂ has been exemplified, another fluorosulfonyl-imide-based salt, such as, for example, AgFSI, and CsFSI, may be used.

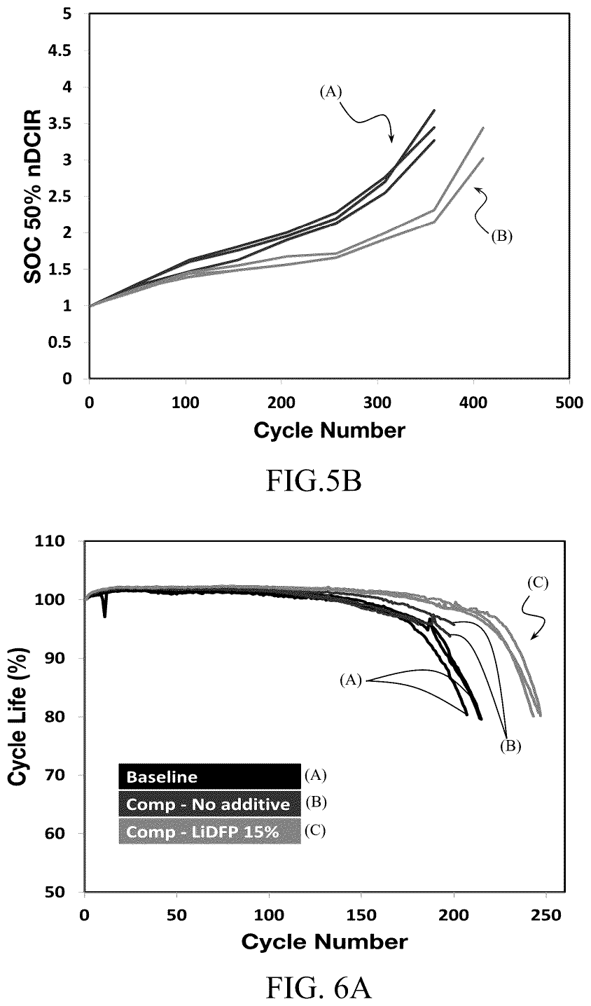

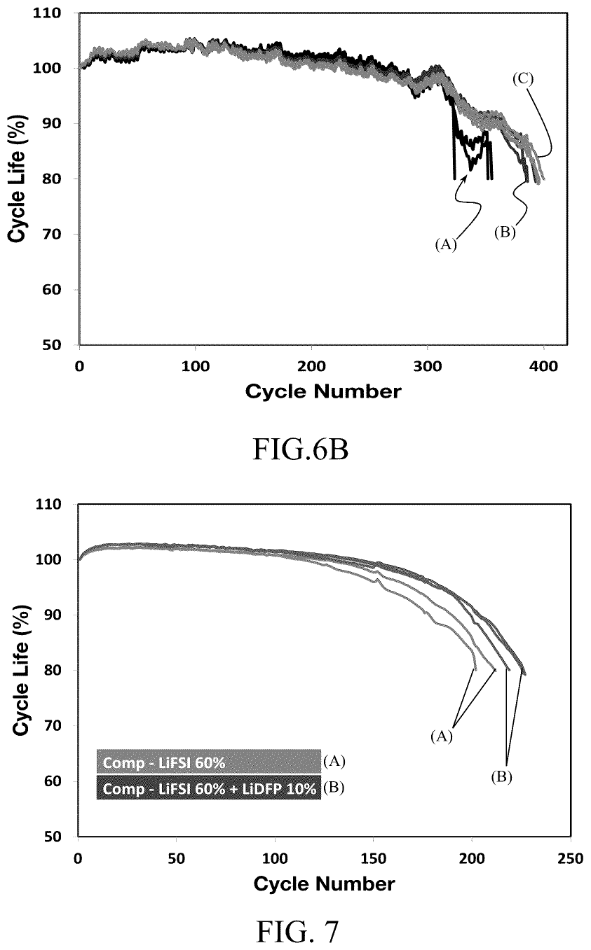

FIGS. 6A and 6B show, respectively the fast-charge and C/3-C/3 cycling performances of cells built with composite anodes containing a lithium difluorophosphate (LiDFP) additive. In comparison to the baseline anode and composite anode with no additive, composite anode with 15 wt % LiDFP additive was found to show ˜20% higher cycle life performance at the fast-charge rate. Moreover, there is also a marginal improvement in the C/3-C/3 cycling performance of composite anodes with LiDFP additive. In addition to potentially increasing the lithium salt concentration of the electrolyte, LiDFP is known to improve the CEI properties and the electrochemical performance of the cathode.

In essence, composite anodes of the present disclosure can function as reservoirs and promote gradual dissolution of functional additives that can enhance the SEI, CEI, and/or electrolyte properties that are favorable for fast-charge durability and cycle life performance.

FIG. 7 shows a fast-charge cycling performance of cells built with composite anodes containing both LiFSI salt and LiDFP additive. In comparison to the composite anode with 60 wt % LiFSI alone, a composite anode with both 60 wt % LiFSI salt and 10 wt % LiDFP additive showed relatively better cycle life performance. This demonstrates the combined benefit of using the composite anode as a reservoir for both salt and a functional additive, wherein the salt helps maintain the electrolyte concentration and the additive enhances the SEI and/or CEI properties of the electrodes. Either alone or in combination with LiFSI salt, a presently preferred range of LiDFP additive is from about 5 wt % to about 30 wt %, and a presently most preferred range is from about 10 wt % to about 15 wt %, although other ranges and values are possible.

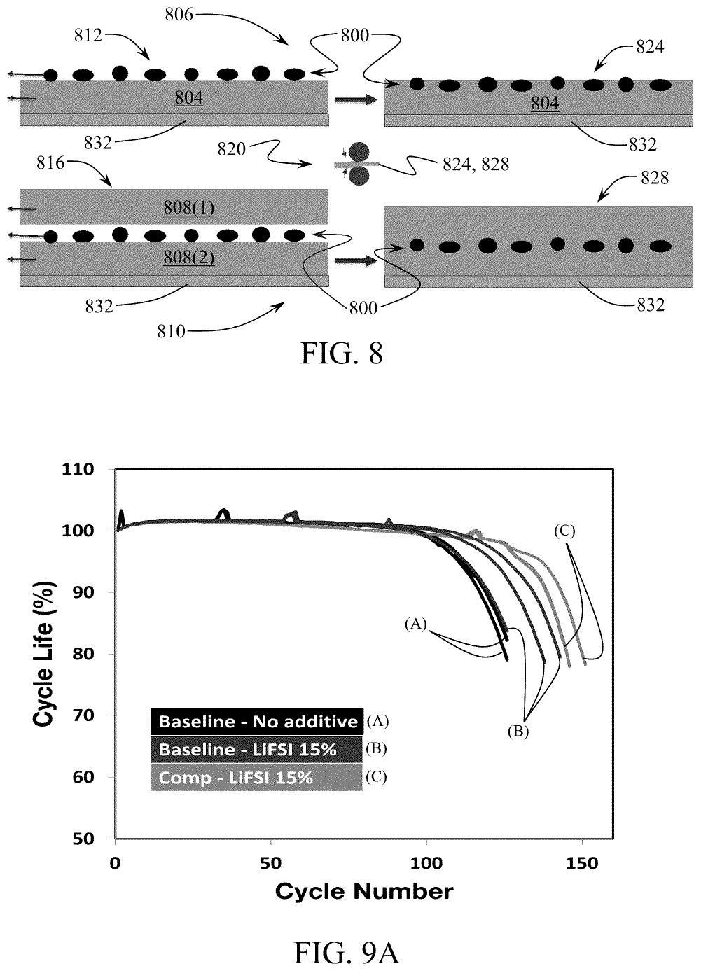

Alternatively to the slurry-coating process described above, composite anodes of the present disclosure can also be fabricated by embedding particulate salt and/or a particulate functional additive on the surface and bulk of the lithium metal foil. As shown in FIG. 8, the particulate(s) 800 could be either pressed on to the surface of a lithium-metal layer 804 (top of FIG. 8) in a surface-embedding process 806 or sandwiched between layers 808(1) and 808(2) of lithium foil (bottom of FIG. 8) in a multilayer-encapsulating process 810. In both cases, the resulting loosely layered assemblies 812 and 816 (FIG. 8, upper and lower lefthand side, respectively) can be calendered 820 (middle of FIG. 8) to form the corresponding composite anodes 824 and 828 (FIG. 8, upper and lower righthand side, respectively), which in this example also includes a current collector 832. This process may, in some cases, not ensure uniform distribution of salt or additives in the bulk of the composite-anode matrix. In such cases, uneven distribution of the salt or additive in the composite anode could lead to irregular dissolution in the electrolyte, and an inconsistent or less-than-optimal performance enhancement of the cell.

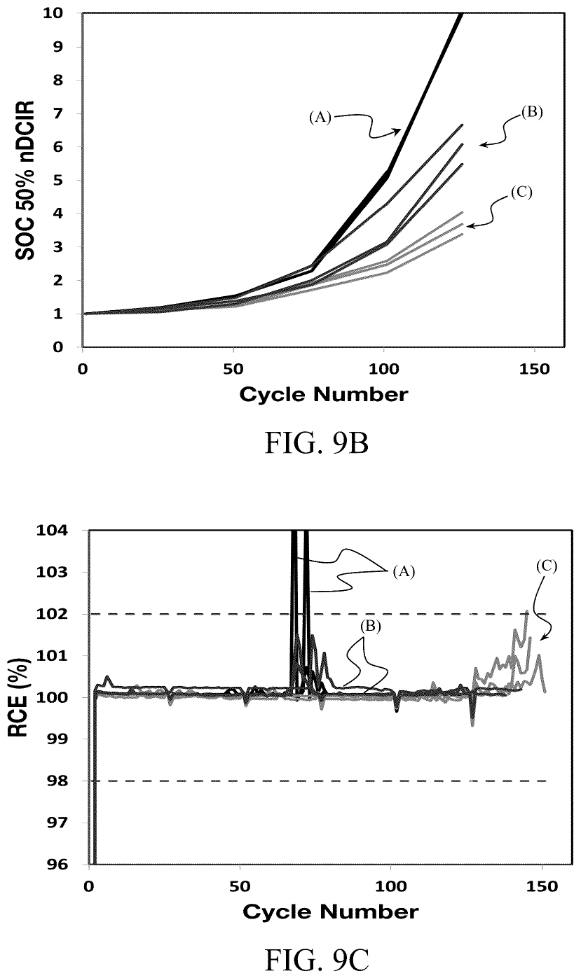

FIG. 9A shows fast-charge cycling performance of cells built with a particulate salt containing baseline anodes made via the above-mentioned surface-embedding process. Although the baseline anode with 15 wt % LiFSI salt embedded on the surface of the lithium foil showed relatively better cycling performance than a baseline anode with no additive, its performance is inconsistent and inferior to the composite anode with 15 wt % LiFSI made via the slurry-coating process (see FIG. 3A). FIGS. 9B and 9C show, respectively, the superior DCIR growth suppression and the Reverse Coulombic Efficiency (RCE) overcharge delay achieved with the salt-containing composite anode, compared to the baseline anode with salt embedded on the surface. These results underscore the importance of uniform salt/additive distribution achieved in the composite anode for consistent performance enhancement of the cell. RCE is explained in detail in U.S. Patent Applicant Publication No. 2024/0097460 titled “METHODS, APPARATUSES, AND SYSTEMS THAT INCLUDE SECONDARY ELECTROCHEMCIAL UNIT ANOMALY DETECTION AND/OR OVERCHARGE PREVENTION BASED ON REVERSE COULOMBIC EFFICIENCY” and published on Mar. 21, 2024, which is incorporated herein by reference for its teachings of RCE.

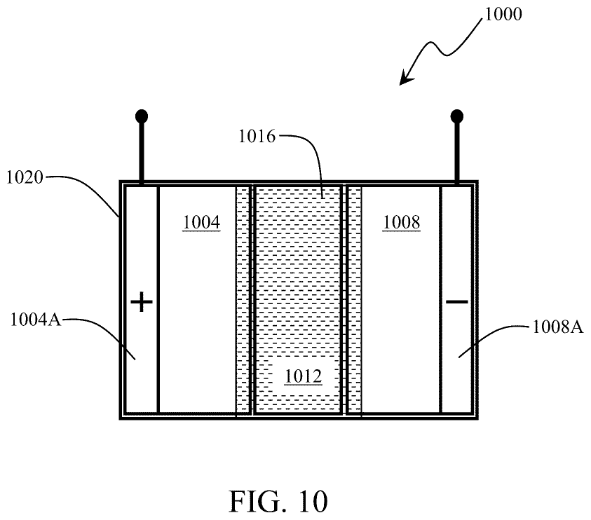

FIG. 10 illustrates a simplified electrochemical energy-storage cell 1000 made in accordance with aspects of the present disclosure. Those skilled in the art will readily appreciate that the electrochemical energy-storage cell 1000 can be, for example, a battery or a supercapacitor. In addition, those skilled in the art will readily understand that FIG. 10 illustrates only some basic functional components of the electrochemical energy-storage cell 1000 and that a real-world instantiation of the electrochemical energy-storage cell, such as a secondary battery or a supercapacitor, will typically be embodied using either a wound construction or a stacked/folded construction. Further, those skilled in the art will understand that the electrochemical energy-storage cell 1000 will include other components, such as electrical terminals, seal(s), thermal shut-down layer(s), and/or vent(s), among other things, that, for case of illustration, are not shown in FIG. 10.

In this example, the electrochemical energy-storage cell 1000 includes a cathode 1004 and composite anode 1008 made in accordance with the present disclosure, and a pair of corresponding respective current collectors 1004A, 1008A. In some embodiments, the composite anode 1008 may be made using at least one of the mixture process of FIG. 1B, the surface-embedding process of FIG. 8, and the layer-encapsulating process of FIG. 8. A porous separator 1012 is located between the cathode 1004 and the composite anode 1008 to electrically separate the cathode and the anode but to allow ions of an electrolyte 1016 to flow therethrough. The porous separator 1012 and/or one, the other, or both of the cathode 1004 and the composite anode 1008, depending on whether porous or not, is/are impregnated with the electrolyte 1016. In FIG. 10, both the cathode 1004 and the composite anode 1008 are illustrated as being at least partially porous and/or having a porous or ionically conductive layer, such as an SEI layer, by way of the electrolyte 1016 being illustrated as extending into them. The electrochemical energy-storage cell 1000 includes a container 1020 that contains the current collectors 1004A, 1008A, the cathode 1004 and the composite anode 1008, the porous separator 1012, and the electrolyte 1016. In some embodiments, the electrochemical energy-storage cell 1000 is part of a greater battery system.

In some embodiments, the electrolyte 1016 comprises an alkali-metal salt and a solvent system, wherein the solvent system comprises one or more solvents. As those skilled in the art will understand, depending upon the type and design of the electrochemical energy-storage cell 1000, each of the cathode 1004 and the composite anode 1008 comprises a suitable material compatible with the alkali-metal ions and other constituents in the electrolyte 1016. Each of the current collectors 1004A, 1008A may be made of any suitable electrically conducting material, such as copper or aluminum, or any combination thereof. The porous separator 1012 may be made of any suitable porous dielectric material, such as a porous polymer, among others.

Various battery and supercapacitor constructions that can be used for constructing the electrochemical energy-storage cell 1000 of FIG. 10, are known in the art. If any of such known constructions is used, a novelty of the electrochemical energy-storage cell 1000 lies in the composite anode 1008. Those skilled in the art will readily appreciate that in stacked constructions made of a plurality of anodes stacked with a plurality of cathodes and a plurality of separators, each anode may have anode-active material on both sides of the corresponding current collector 1008A.

In some aspects, the present disclosure is directed to methods of manufacturing an electrochemical energy-storage cell comprising a composite anode of the present disclosure, such as composite anode 1008 of FIG. 10. The electrochemical energy-storage cell may have any one or more of the properties of electrochemical energy-storage cells described above. For example, in some embodiments, methods of manufacturing the electrochemical energy-storage cell 1000 of FIG. 10 comprise placing the composite anode 1008 in the container 1020, placing the porous separator 1012 in the container on top of the anode, placing the cathode 1004 in the container on top of the porous separator, adding the electrolyte 1016 to the container, and sealing the container. Placing various of these elements “on top” of each other is not meant to be limited to a particular direction in space—the electrochemical energy-storage cell may be assembled in any direction. As noted above, the construction of an electrochemical energy-storage cell 1000 may include winding the various layers, stacking the various layers, or folding the various layers, or any practicable combination thereof.

In summary, composite anodes with salt/additive reservoir were found to improve cell performance and can achieve ˜20% increase in cycle life at fast-charge & C/3-C/3 test. In addition, they were also found to suppress cell overcharge and lower resistance growth during cycling.

In some embodiments, the electrolyte is a high-concentration electrolyte (HCE) having a salt concentration in a range of about 2M to about 6M. In some embodiments, the electrolyte is a localized-high-concentration electrolyte (LHCE) having a salt concentration in a range of about 1M to about 2M. LCHE typically includes two primary solvents, wherein the salt dissolves preferentially in one solvent over the other. In some embodiments, the solvent for an HCE may be selected from a group that includes dimethyl sulfamoyl fluoride (DMSF), dimethoxyethane (DME), and ethylene carbonate (EC), among others. For LHCE, any of these or other solvents may be substituted with suitable LHCE solvents, as known in the art.

In an example, the electrolyte has an initial LiFSI salt concentration before cycling of about 3M. It is estimated that after cycling about 70% to 80% of the initial salt (>2M) in the electrolyte is depleted. In this example, a composite anode having 120 wt % LiFSI could potentially replenish about 1M to about 2M of the salt in the electrolyte depending on the amount of electrolyte used in the cell. However, as salt is added in the anode, the relative amount of lithium-metal of the anode-active material decreases and negatively affects cycle performance. Generally and in this example, beyond about 120 wt % LiFSI in the composite anode the negative effect of lowering the lithium-metal of the anode-active material overshadows the positive effect of the replenishment salt in the reservoir of the composite anode.

The salt in the electrolyte appears to deplete gradually over cycling, so embodiments of the composite anode may be structures so as to release or give up replenishment salt stored therein gradually, such as to keep pace with the salt depletion in the electrolyte. The above-described slurry-coating method of forming a composite anode may enable this gradual replenishment more easily than other composite-anode formation techniques, such as the techniques illustrated in FIG. 8. In some embodiments, multiple layers of slurry coatings may be serially applied to the anode (e.g., to a sheet-type current collector (e.g., copper or aluminum)), wherein the differing layers have differing relative amounts of the replenishment salt. For example, a three-layer composite lithium-metal anode for use in an LiFSI-based cell may have layers of increasing amounts of replenishment salt from the outermost layer to the innermost layer, with the layers having 10 wt %, 30 wt %, and 60 Wt %, respectively and relative to the lithium-metal active material in that layer, of replenishment LiFSI for replacing LiFSI in the electrolyte as it is depleted over cycling. This is but one example, and other embodiments may have more or fewer layer and/or have other amounts of replenishment salt. As those skilled in the art will readily appreciate, many composite anodes of the present disclosure will have anode-active material on both sides of a current collector. In the immediately preceding example, this would mean that the above-mentioned three layers would be present on each side of a current collector.

In some embodiments it can be desirable to match the cations of the primary salt in the electrolyte to the replenishment salt and/or a functional additive. For example, if LiFSI is the electrolyte's primary salt, the replenishment salt may likewise be LiFSI. As another example in which LiFSI is the electrolyte's primary salt, a functional additive may also have the FSI anion, such as in Mg(FSI)₂, AgFSI, and CsFSI, among others. Of course, the anion may be other than FSI, such as, but not limited to, bis(trifluoromethanesulfonyl)imide (TFSI), fluorosulfonyl-trifluoromethanesulfonyl imide (FTFSI), and 1,1,2,2,3,3-hexafluoropropane-1,2-disulfonimide (CPFSI), among others.

In some embodiments, fewer than all of the anodes within a cell may be a composite anode made in accordance with the present disclosure. For example, for double-sided anodes, only one side of each anode may include one or more composite anode layers disclosed herein or apparent to anyone of ordinary skill in the art after reading this disclosure. As another example, every other one or every third one of the anodes in a core stack may be a composite anode of the present disclosure. Those skilled in the art will readily appreciate the myriad of possibilities for making composite anodes that are fewer than all of the anodes within a cell.

Embodiments of the present disclosure may also be used to improve the safety characteristics of lithium-metal batteries and may help to achieve lower hazard levels in abuse tests. For example, a composite anode of this disclosure could be used as a reservoir of additive materials that reduce the reactivity of lithium during thermal runaway. In particular and in a lithium-metal battery, each additive could be one that alloys with lithium at high temperature so as to delay lithium melting and reduce severity of thermal runaway. These additives include but not limited to metals, such as Bi, Mg, Cu, and Al, among others, and metal halides, such as, MgF₂, InF₃, LaF₃, BaF₂, CaF₂, ZnF₂, and AlF₃, among others, that react with lithium at high temperature forming alloys having higher melting point than lithium. The composite anode could also be used as a reservoir of one or more flame-retardant materials such as phosphates that inhibit the flammability of liquid electrolytes during thermal runaway, or as a reservoir of one or more additives such as petroleum waxes that passivate lithium metal surface at high temperature.

The above embodiments are merely illustrative of the principles of the present inventions and their efficacies, and are not intended to limit the present inventions. Any person skilled in the art may modify or change the above embodiments without violating the spirit and scope of the present inventions. Therefore, all equivalent modifications or changes made by persons having ordinary knowledge in the art without departing from the spirit and technical ideas disclosed in the present inventions shall be covered by the claims of the present inventions.

Various modifications and additions can be made without departing from the spirit and scope of this disclosure. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of these inventions.

Exemplary embodiments have been disclosed above and illustrated in the accompanying drawings. It will be understood by those skilled in the art that various changes, omissions and additions may be made to that which is specifically disclosed herein without departing from the spirit and scope of the present inventions.

What is claimed is:

1. An electrochemical energy-storage cell, comprising:
a container;
a core contained within the container, wherein the core comprises an anode, a cathode, and a separator electrically separating the anode and the cathode; and
an electrolyte contained within the container and in functional contact with the core so as to conduct, during operation of the electrochemical energy-storage cell, ions between the anode and the cathode, the electrolyte comprising a first salt and solvent and having a salt concentration;
wherein the anode includes:
an alkali metal as an anode-active material; and
a second salt incorporated into the alkali metal, the second salt provided in an amount determined as a function of the salt concentration of the electrolyte.

2. The electrochemical energy-storage cell of claim 1, wherein the first salt is a first alkali-metal salt, the second salt is a second alkali-metal salt.

3. The electrochemical energy-storage cell of claim 1, wherein the first and second salts can be the same as one another or different from each other.

4. The electrochemical energy-storage cell of claim 1, wherein the electrolyte is a high-concentration electrolyte in which the salt concentration is in a range of about 2M to about 6M.

5. The electrochemical energy-storage cell of claim 1, wherein the electrolyte is a localized-high-concentration electrolyte in which the salt concentration is in a range of about 1M to about 2M.

6. The electrochemical energy-storage cell of claim 1, wherein the second salt is provided in a range of about 5 wt % to about 120 wt % relative to the alkali metal of the anode-active material, more preferably in a range of about 30 wt % to about 60 wt % relative to the alkali metal of the anode-active material.

7. The electrochemical energy-storage cell of claim 6, wherein the alkali metal of the anode active material is either lithium or sodium or their alloy material.

8. The electrochemical energy-storage cell of claim 1, wherein:
the anode contains first particles of the alkali metal and second particles of the second salt; and
the first and second particles have been calendered into an anode layer.

9. The electrochemical energy-storage cell of claim 1, wherein the first and second salts can be the same salt with same cation and same anion, or different salts with either different cations or different anions or different in both anion and cation.

10. The electrochemical energy-storage cell of claim 9, wherein the cation of the first salt is a lithium cation, and wherein the cation of the second salt is a lithium or non-lithium cation.

11. The electrochemical energy-storage cell of claim 10, wherein the non-lithium cation is selected from the group consisting of magnesium, silver, and cesium.

12. The electrochemical energy-storage cell of claim 1, wherein anion of the first and second salts are selected from the group consisting of FSI, TFSI, FTFSI, and CPFSI.

13. The electrochemical energy-storage cell of claim 1, wherein the solvent(s) include at least one solvent selected from the group consisting of DMSF, DME, and EC.

14. The electrochemical energy-storage cell of claim 1, wherein the anode further comprises a functional additive of the form M-FSI, wherein M is a metal and FSI is bis(fluorosulfonyl)imide, wherein the M-FSI is in an amount of about 5 wt % to about 30 wt % relative to the alkali-metal of the anode-active material.

15. The electrochemical energy-storage cell of claim 14, wherein the functional additive is selected from the group consisting of LiFSI, Mg(FSI)₂, AgFSI, and CsFSI.

16. The electrochemical energy-storage cell of claim 1, wherein the anion of the first and second salt is based on an FSI ion.

17. The electrochemical energy-storage cell of claim 1, wherein the cation of the first and second salt comprises lithium.

18. An electrochemical energy-storage cell, comprising:
a container;
a core contained within the container, wherein the core comprises an anode, a cathode, and a separator electrically separating the anode and the cathode; and
an electrolyte contained within the container and in functional contact with the core so as to conduct, during operation of the electrochemical energy-storage cell, ions between the anode and the cathode, the electrolyte comprising an alkali-metal salt and solvent and having a salt concentration;
wherein the anode includes:
an alkali metal as an anode-active material; and
a functional additive incorporated into the alkali metal as particulates, wherein the functional additive is selected and provided in an amount to, at least one of:
contribute to formation of a solid-electrolyte interphase layer on the anode during charge-discharge cycling of the electrochemical energy-storage cell;
contribute to formation of a cathode-electrolyte interphase layer on the cathode during charge-discharge cycling of the electrochemical energy-storage cell; and
participate in chemical reduction on the anode so as to free ions of the alkali metal of the anode-active material during charge-discharge cycling of the electrochemical energy-storage cell.

19. The electrochemical energy-storage cell of claim 18, wherein the alkali metal and the functional metal are each provided as particulates formed into a unitary monolithic layer.

20. A method of forming an anode for an electrochemical energy-storage cell based on an electrolyte having a primary salt, wherein the electrochemical energy-storage cell includes a cathode, the method comprising:
providing a current collector;
coating a first precursor slurry onto the current collector so as to provide a first composite anode coating, wherein the first precursor slurry comprises:
an alkali metal, in particulate form, as an anode-active material;
a coating solvent for enabling the coating; and
at least one of, in particulate form:
a replenishment salt selected and provided in an amount to replenish the primary salt as the primary salt is depleted during charge-discharge cycling of the electrochemical energy-storage cell; and
a functional additive selected and provided in an amount to, at least one of:
contribute to formation of a solid-electrolyte interphase layer on the anode during charge-discharge cycling of the electrochemical energy-storage cell;
contribute to formation of a cathode-electrolyte interphase layer on the cathode during charge-discharge cycling of the electrochemical energy-storage cell; and
participate in chemical reduction on the anode so as to free ions of the alkali metal of the anode-active material during charge-discharge cycling of the electrochemical energy-storage cell;
causing the first composite anode coating to cure so as to form a first composite anode layer; and
calendering the first composite anode layer and the current collector so as to compact the first composite anode layer.
